(19) United States
(12) Patent Application Publication
(10) Pub. No.: US 2013/0111801 A1
(43) Pub. Date: May 9, 2013

(54) Bug Interception Device

(71) Applicants: Jeffrey White, New Egypt, NJ (US); Phillip Cooper, Yardley, PA (US)

(72) Inventors: Jeffrey White, New Egypt, NJ (US); Phillip Cooper, Yardley, PA (US)

(21) Appl. No.: 13/673,299

(22) Filed: Nov. 9, 2012

Related U.S. Application Data
(60) Provisional application No. 61/557,775, filed on Nov. 9, 2011.

(51) Int. Cl. A01M 1/10

(52) U.S. Cl. CPC A01M 1/103
USPC 43/109

(57) ABSTRACT

The present invention describes a bug interception device that is designed to capture crawling bugs, for example, arthropods such as bed bugs, as they walk around an infested structure. One or more embodiments of the present disclosure may be found in a circular device, for example, a device with a circular footprint as it sits on the floor. One or more embodiments of the present disclosure may be found in a pyramid device, for example, a device with a square footprint and a three dimensional shape resembling a pyramid. One or more embodiments may include one or more outer access surfaces adapted to allow bugs to crawl up onto the device. One or more embodiments may include one or more rims adapted to cause bugs to fall into a capture well.

### CROSS-REFERENCE TO RELATED APPLICATIONS

This application claims priority from U.S. Provisional Patent Application No. 61/557,775 filed on Nov. 9, 2011. The disclosure of this provisional application is incorporated by reference herein in its entirety.

### FIELD

The present invention relates to preventing bugs from interacting with humans, and more particularly relates to one or more bug interception devices.

### BACKGROUND

Bed bugs have been a problem for thousands of years because they suck the blood of humans.

Pitfall traps can be valuable tools to assist in proactive monitoring of potential bed bug infestations as well as assisting in the control of known infestations. Bed bugs will travel to areas where people are sleeping and randomly move throughout a structure that is infested and encounter strategically placed pitfall devices and become caught by the trap well.

Previous designs, while proven to suffice at catching bed bugs, have all had their shortcomings in design.

### SUMMARY

The present invention relates to a bug interception device that is designed to capture crawling bugs, for example, arthropods such as bed bugs, as they walk around an infested structure. One or more embodiments of the present invention may be found in a circular device, for example, a device with a circular footprint as it sits on the floor. One or more embodiments of the present disclosure may be found in a pyramid device, for example, a device with a square footprint and a three dimensional shape resembling a pyramid. One or more embodiments may include one or more outer access surfaces adapted to allow bugs to crawl up onto the device. One or more embodiments may include an outer rim adapted to cause bugs to fall into a capture well. One or more embodiments may include an inner rim adapted to cause bugs to fall into a capture well. One or more embodiments may include an inner leg well adapted to accept a leg of a piece of furniture or other apparatus.

One or more embodiments of the invention may be found in a bug interception device for use with a leg of an apparatus. The bug interception device may include a circular shaped capture well having an inner capture well wall, an outer capture well wall and a capture well floor. The bug interception device may include a circular shaped inner leg well for receiving a leg of the apparatus. The inner leg well may have an inner leg well surface and an inner leg well floor. The inner leg well may be secured to said capture well and may be located radially inwardly from said inner capture well wall. The bug interception device may include an outer access surface disposed relative to said capture well and located radially outwardly from said outer capture well wall. The bug interception device may include an inner rim located at the top of said inner capture well wall and the top of said inner leg well surface. The bug interception device may include an outer rim located at the top of said outer access surface and the top of said outer capture well wall. The outer rim may have (1) a top surface of a curved configuration, (2) an outer surface merging with said outer access surface and (3) an inner surface merging with said outer capture well wall. The top surface may have a first portion being texturized and a second portion being smooth.

The outer surface of said outer rim may be texturized, and the inner surface of said outer rim may be smooth. The top surface of said outer rim may be texturized beginning from a line outwardly, and the top surface of said outer rim may be smooth beginning from said line inwardly. The line may form approximately a 75 degree angle in relation to a plane that runs perpendicular to a central axis, the central axis being perpendicular to said inner leg well floor. The inner rim may have (1) a top surface of a curved configuration, and (2) an outer surface merging with said inner capture well wall and (3) an inner surface merging with said inner leg well surface. A first portion of said top surface of said inner rim may be texturized and a second portion of said top surface of said inner rim may be smooth. The outer access surface may be sloped at an angle relative to a central axis that runs perpendicular to said inner leg well floor, said angle being approximately 30 degrees. The inner capture well wall and said outer capture well wall may each be oriented approximately 90 degrees in relation to a plane that runs parallel to said inner leg well floor. The outer access surface may include an outer textured surface, and said inner leg well surface and said inner leg well floor may each include an inner textured surface. The inner capture well wall, said outer capture well wall and said capture well floor may each include a smooth surface.

One or more embodiments of the invention may be found in a bug interception device that includes a capture well having an inner capture well wall, an outer capture well wall and a capture well floor. The bug interception device may include an inner leg well, said inner leg well having an inner leg well surface and an inner leg well floor. The inner leg well may be secured to said capture well and be located radially inwardly from said inner capture well wall. The bug interception device may include an outer access surface disposed relative to said capture well and located radially outwardly from said outer capture well wall. The bug interception device may include an inner rim located at the top of said inner capture well wall and the top of said inner leg well surface. The bug interception device may include an outer rim located at the top of said outer access surface and the top of said outer capture well wall. The outer rim may have a top surface of a curved configuration merging with said outer access surface and merging with said outer capture well wall. The top surface may have a first portion being texturized and a second portion being smooth.

The top surface of said outer rim may be texturized beginning from a line outwardly, and said top surface of said outer rim may be smooth beginning from said line inwardly. The line may form approximately an obtuse angle in relation to a plane that runs perpendicular to a central axis, said central axis being perpendicular to said inner leg well floor. The inner rim may have another top surface of a curved configuration, said another top surface having a first portion being texturized and a second portion being smooth.

One or more embodiments of the invention may be found in a bug interception device for use with a leg of an apparatus. The bug interception device may include a circular shaped capture well having an inner capture well wall, an outer capture well wall and a capture well floor. The bug interception device may include a circular shaped inner leg well for receiving a leg of the apparatus, said inner leg well having an inner leg well surface and an inner leg well floor. The inner leg well may be secured to said capture well and be located radially inwardly from said inner capture well wall. The bug interception device may include an outer access surface disposed relative to said capture well and located radially outwardly from said outer capture well wall. The outer access surface may be sloped at an angle relative to a central axis that runs perpendicular to said inner leg well floor, said angle being approximately 30 degrees. The bug interception device may include an outer rim located at the top of said outer access surface and the top of said outer capture well wall. The bug interception device may include an inner rim located at the top of said inner capture well wall and the top of said inner leg well surface.

The outer access surface may include an outer textured surface. The inner leg well surface and said inner leg well floor may each include an inner textured surface. The inner capture well wall, said outer capture well wall and said capture well floor may each include a smooth surface. The outer rim may have (1) a top surface of a curved configuration, and (2) an outer surface merging with said outer access surface and (3) an inner surface merging with said outer capture well wall. A first portion of said top surface may be texturized a second portion of said top surface may be smooth. The outer surface of said outer rim may be texturized, and said inner surface of said outer rim may be smooth. The top surface of said outer rim may be texturized from a line outward, and said top surface of said outer rim may be smooth from said line inward. The line may form approximately a 75 degree angle in relation to a plane that runs perpendicular to a central axis, said central axis being perpendicular to said inner leg well floor. The inner capture well wall and said outer capture well wall may each be oriented approximately 90 degrees in relation to a plane that runs parallel to said inner leg well floor.

One or more embodiments of the invention may be found in a bug interception device that includes a circular shaped capture well having a capture well wall and a capture well floor. The bug interception device may include three or more outer access surfaces disposed relative to said capture well and located radially outwardly from said capture well wall. The bug interception device may include three or more corner edges, each corner edge being formed by the meeting of two outer access surfaces. The bug interception device may include a rim located at the top of said outer access surfaces and the top of said capture well wall. The rim may have (1) a top surface of a curved configuration, (2) an outer surface merging with said outer access surfaces and (3) an inner surface merging with said capture well wall. A first portion of said top surface of said rim may be texturized a second portion of said top surface of said rim may be smooth.

The bug interception device may include three or more triangular shaped corner areas, each triangular shaped corner area being located near a corner edge and near said rim. The bug interception device may include a cylindrical wall merging said triangular shaped corner areas to said rim. The triangular shaped corner areas and an outside surface of said cylindrical wall may each include a textured surface. The outer access surfaces may each be sloped at an angle relative to a central axis that runs perpendicular to said capture well floor, said angle being approximately 30 degrees. The capture well wall may be oriented approximately 90 degrees in relation to a plane that runs parallel to said capture well floor.

These and other advantages, aspects and novel features of the present disclosure, as well as details of an illustrated embodiment thereof, will be more fully understood from the following description and drawings. It is to be understood that the foregoing general descriptions are exemplary and explanatory only and are not restrictive of the disclosure as claimed.

### BRIEF DESCRIPTION OF THE DRAWINGS

FIG. 1 depicts an angled top view illustration of a bug interception device with a circular footprint, in accordance with one embodiment of the present invention.

FIG. 2 depicts a side transparent view illustration of a bug interception device with a circular footprint, in accordance with one embodiment of the present invention.

FIG. 3 depicts a top down view illustration of a bug interception device with a circular footprint, in accordance with one embodiment of the present invention.

FIG. 4 depicts a side cross sectional view illustration of a bug interception device with a circular footprint, in accordance with one embodiment of the present invention.

FIG. 5A depicts a side cross sectional close up view illustration of a capture well, in accordance with one embodiment of the present invention.

FIG. 5B depicts a side cross sectional close up view illustration of a rim or lip, in accordance with one embodiment of the present invention.

FIG. 6 depicts a side cross sectional close up view illustration of an inner leg well floor, in accordance with one embodiment of the present invention.

FIG. 7 depicts a side cross sectional close up view illustration of an inner leg well floor, in accordance with one embodiment of the present invention.

FIGS. 8A and 8B depict angled top views of a bug interception device with a square footprint and a three dimensional shape resembling a pyramid, in accordance with one embodiment of the present invention.

FIG. 9 depicts an angled side close up view illustration of a bug interception device with a square footprint and a three dimensional shape resembling a pyramid, in accordance with one embodiment of the present invention.

### DETAILED DESCRIPTION

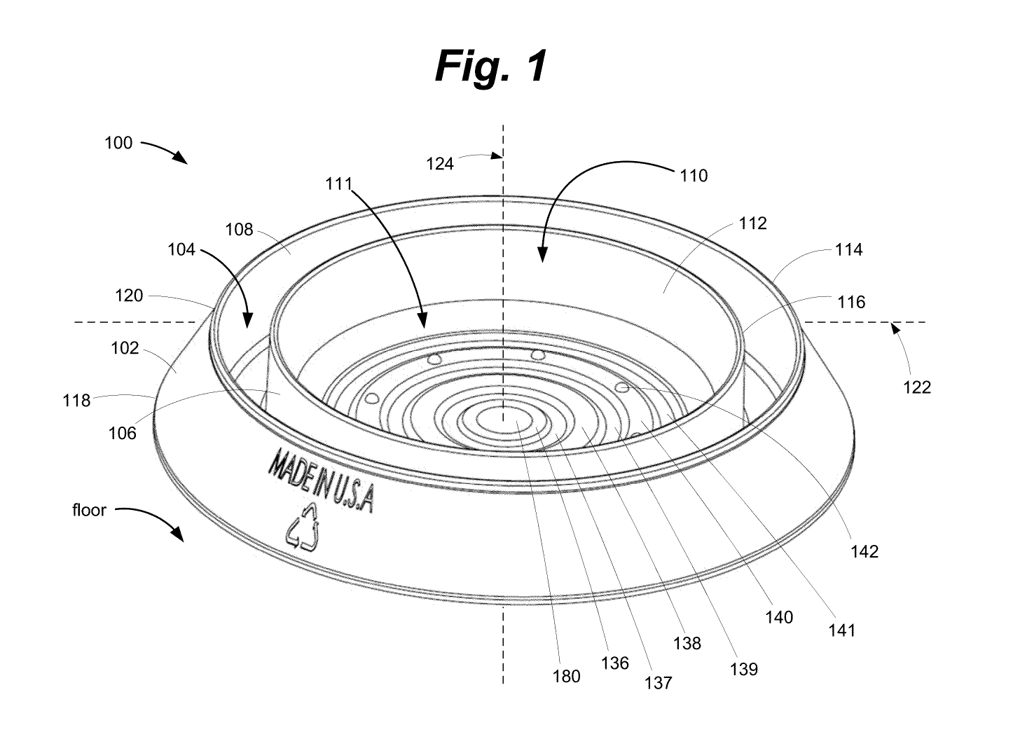

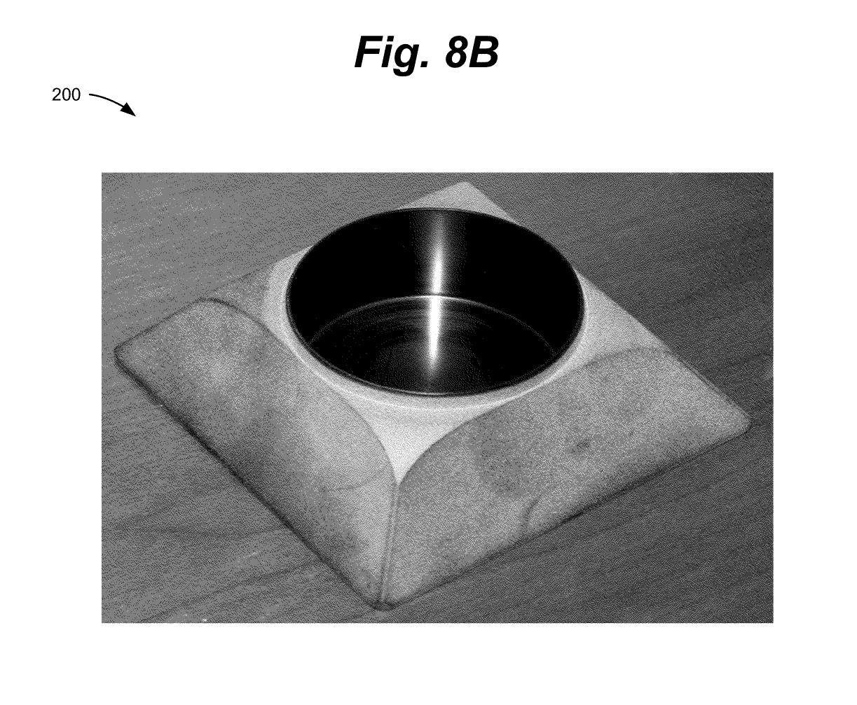

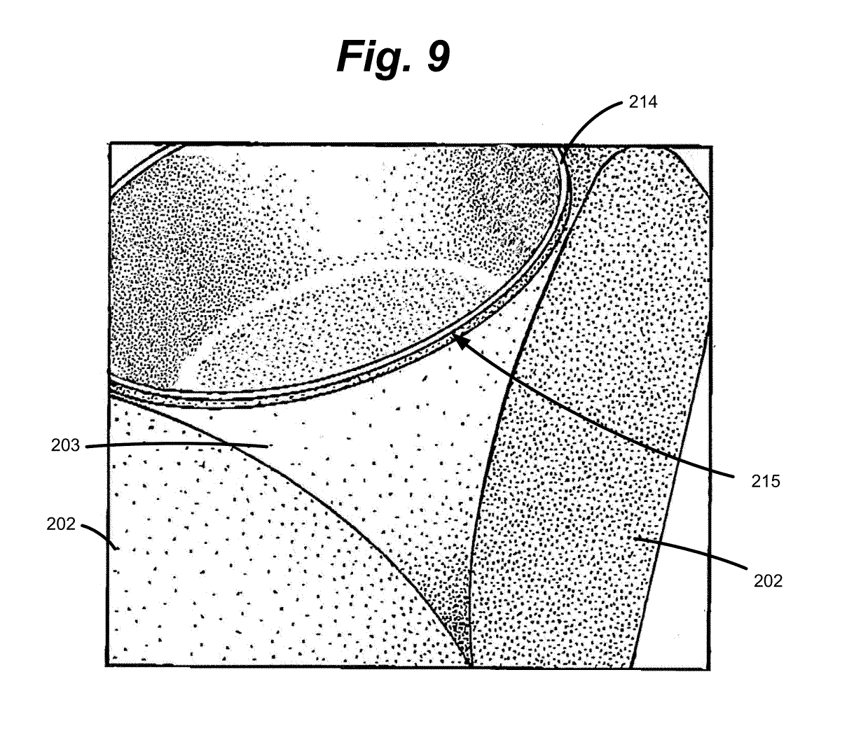

The present invention is directed to a bug interception device that is designed to capture crawling bugs, for example, arthropods such as bed bugs, as they walk around an infested structure. One or more embodiments of the present invention may be found in a circular device, for example, a device similar to the one depicted in FIGS. 1-7. One or more embodiments of the present invention may be found in a pyramid device, for example, a device similar to the one depicted in FIGS. 8 and 9. One or more embodiments of the present disclosure may be found in devices of various other shapes, and the descriptions provided herein of the circular device and the pyramid device are not intended to limit the scope of the present disclosure.

FIGS. 1-7 depict illustrations of a bug interception device 100. The bug interception device of FIGS. 1-7 may be referred to as a circular device, for example, because the footprint of the device as it rests on the floor is shaped like a circle.

Referring to FIG. 1, bug interception device 100 is shown, where the bug interception device rests on a floor or other surface. For example, the bug interception device 100 may be placed under a leg of a piece of furniture or other apparatus. In one or more embodiments of invention, the device 100 comprises at least one outer access surface 102, a capture well 104 defined by inner and outer capture well walls or surfaces 106, 108, an inner leg well 110 defined by at least one inner leg well surface 112, and a set of lips or rims (e.g., outer rim 114 and inner rim 116).

The number of outer access surfaces 102 may depend on the shape of the footprint of the device as it sits on the floor. For example, the footprint of the device as it sits on the floor may be circular or oval and have a single outer access surface 102 (see FIG. 1). In another example, the footprint may be square or rectangle shaped and have four outer access surfaces. Although various descriptions provided herein may refer to a single access surface, it should be understood that a bug interception device may include more than one.

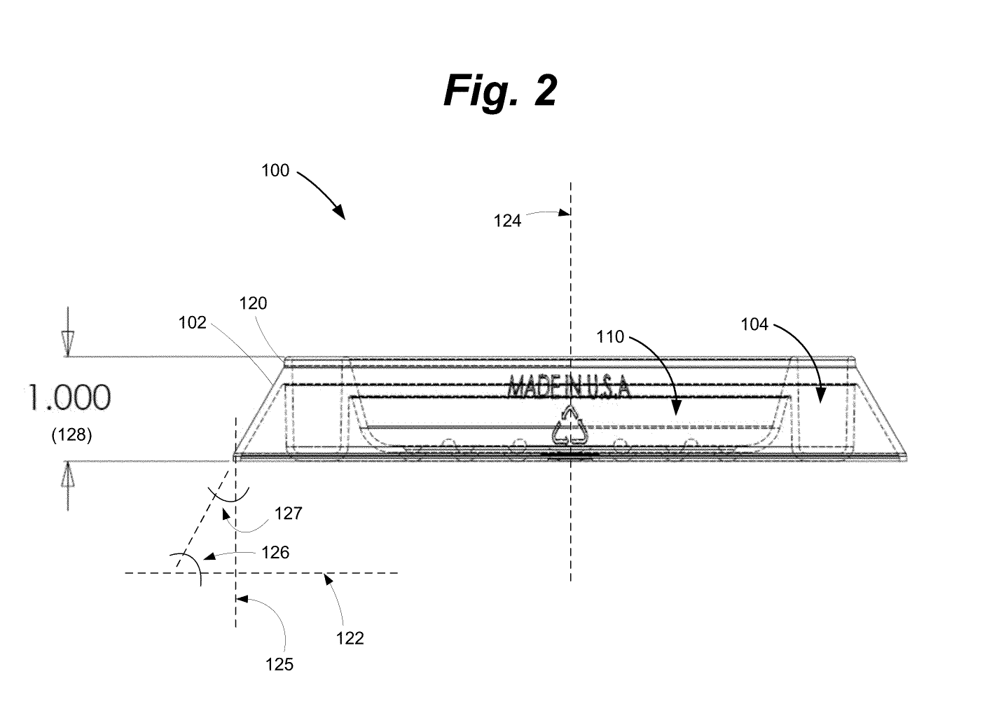

The outer access surface 102 may have a positive slope, going from its bottom end 118 to its top end 120, in relation to a plane 122 parallel to the floor and perpendicular to the center axis 124 of the device. In this respect, the outer access surface 102 may form an angle 126 relative to plane 122 parallel to the floor (see FIG. 2). The angle 126 of the access surface 102 may be important when considering the overall size of the device (e.g., the height) and the amount of traction that is needed on the access surface 102. For example, if the angle is too low, the device may become large and inconvenient, and if the angle is too high, bugs may face a steep slope when attempting to climb the access surface 102. The steeper the slope (e.g., the greater the angle 126), the more traction that is required on the access surface 102. As one example, the access surface 102 may be sloped at an angle 126 of approximately 60 degrees (e.g., between 55 and 65 degrees) in relation to plane 122 (see FIG. 2). This configuration may also create an angle 127 of approximately 30 degrees (e.g., between 25 and 40 degrees) in relation to a plane 125 perpendicular to the center axis 124. Other angles may be used in various other embodiments. For example, the angles may vary by a factor of 10 percent, 20 percent or greater, or any percentage in between.

One purpose of the outer access surface may be to lure or lead a bed bug up onto the device, providing the bedbug with traction that the bedbug needs to walk up onto the device. The bedbug may walk up the outer access surface and proceed to the outer rim of the device.

The inner leg well 110 is defined by at least one inner leg well surface 112 and an inner leg well floor 111. The number of inner leg well surfaces 112 may depend on the shape of the inner leg well 110. For example, if the footprint of the device as it sits on the floor is circular or oval, inner leg well 110 may be cone shaped (see FIG. 2). In this example, device 100 may include a single inner leg well surface 112. Although the following descriptions may refer to a single inner leg well surface 112, it should be understood that the device may include more than one, for example, if the footprint of the device as it sits on the floor is square.

The device 100 may include a set of lips or rims 114, 116 at the top of the device 100. The top-view or bird's-eye-view contour of the rims may depend on the shape of the footprint of the device 100 as it sits on the floor. For example, if the footprint of the device as it sits on the floor is circular or oval, rims 114, 116 may be circularly disposed around the top of the device 100. In another example, the footprint of the device may be square and the rims may be composed of four straight rim segments.

The outer rim 114 is located at the meeting of the top of the outer access surface 102 and the top of the outer capture well wall 108. The access surface 102 and the outer capture well wall 108 may each transition into the outer rim 114. The inner rim 116 is located at the meeting of the top of the inner capture well wall 106 and the top of the inner leg well surface 112. The inner capture well wall 106 and the inner leg well surface 112 each transition into the inner rim 116. Although the following descriptions may explain the properties of the outer rim or the inner rim, similar descriptions may apply to each of the outer rim and/or the inner rim.

Referring to FIG. 2, the cross sectional length of the access surface 102 may be straight or curved. The embodiment shown in FIG. 2 may show a straight access surface 102, but other embodiment may have a curved access surface. The height 128 of device 100, measured vertically (or perpendicularly) from the floor may vary. As one example, the height 128 of the device 100 may be approximately 1 inch, as shown in FIG. 2. As another example, the height 128 may be about 0.9 inches. Other heights may be used in various other embodiments.

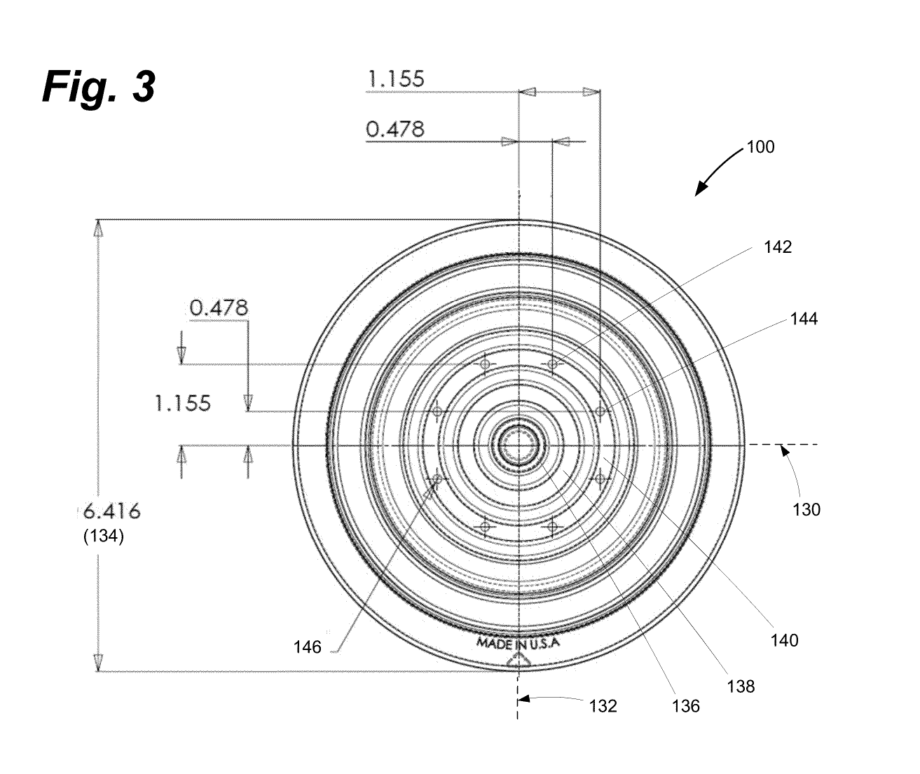

FIG. 3 shows an illustration of a top-down or bird's eye view of the bug interception device 100. FIG. 3 shows an imaginary X axis reference line 130 and an imaginary Y axis reference line 132. As can be seen in FIG. 3, the device 100 may have a base diameter 134. As one example, the embodiment of FIG. 3 shows a base diameter 134 of 6.416 inches. Other base diameters may be used in various other embodiments. As can be seen in FIG. 3 (and FIG. 1), the device 100 may have a number of raised rings (e.g., rings 136, 138, 140) on the inner leg well floor or base 111 of the device 100. Raised rings may add strength to the device 100, for example, to better support the weight of a bed leg. In other embodiments of the present disclosure, the inner leg well floor 111 may include fewer or no raised rings.

In some embodiments, one or more of the raised rings (e.g., raised ring 140) may include one or more raised knobs (e.g., raised knobs 142, 144, 146). Knobs may be adapted to slow or prevent a leg (e.g., a leg of a bed) with wheels from rolling around once placed down into the inner leg well 110. Various embodiments may have a variety of numbers of raised rings and/or raised knobs. The example of FIG. 3 (see also FIG. 1) shows 8 raised knobs, relatively evenly spaced around raised ring 140. As one specific example, the perpendicular distance between Y axis reference line 132 and an imaginary reference line extending from knob 144 may be approximately 1.155 inches, and the perpendicular distance between Y axis reference line 132 and an imaginary reference line extending from knob 142 may be approximately 0.478 inches. Similar measurements may exist with other knobs relative to the X axis reference line 130, as shown in FIG. 3. These are just some example measurements, and various other embodiments may include various other numbers of knobs placed in various other configurations.

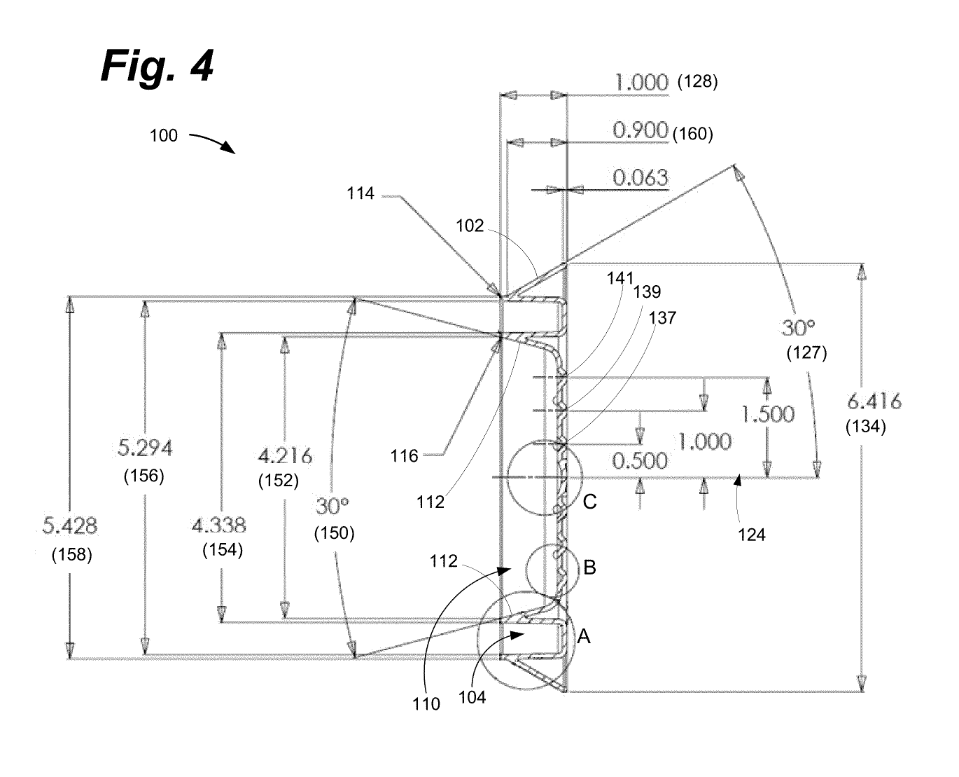

FIG. 4 shows an illustration of a cross sectional view of the bug interception device 100 (e.g., rotated 90 degrees counter clockwise). FIG. 4 shows example detailed measurements for various features and structures of the device 100. Some of these features and/or measurements are the same as those explained above. For example, angle 127, height 128, base diameter 134, outer rim 114, inner rim 116, and inner leg well surface 112.

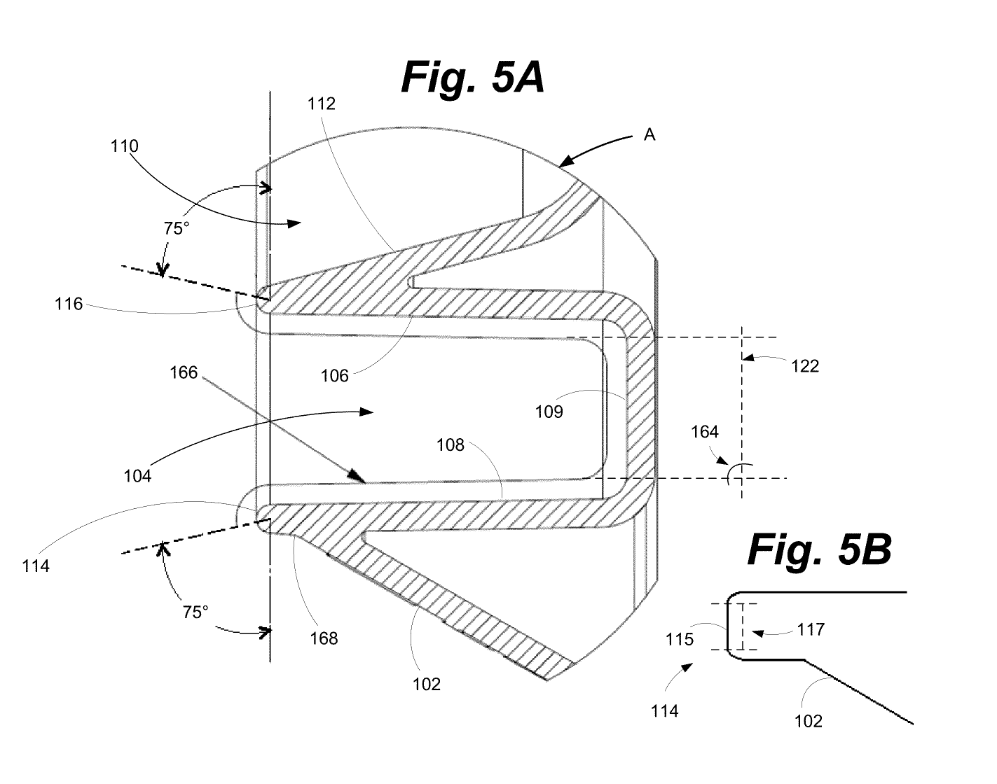

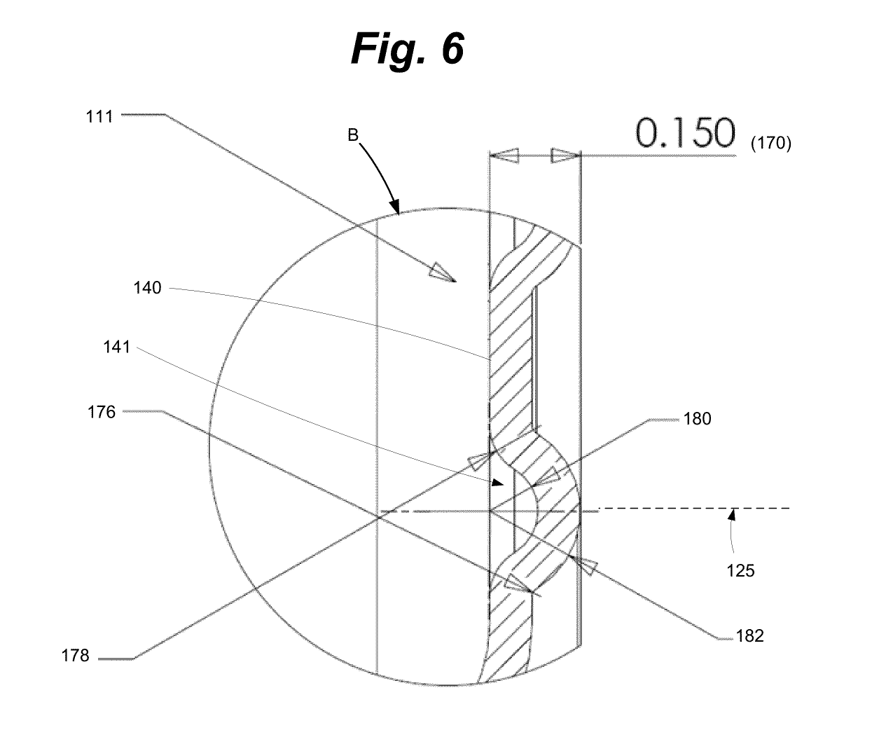

FIG. 4 may show additional details about the outer rim 114 and inner rim 116, for example, the height of outer rim 114. The outer rim 114 may be raised vertically a small distance from the base 168 (see FIG. 5A) of the rim or from the top end 120 (see FIG. 1) of the access surface 102. Inner rim 116 may be raised in a similar manner. The amount that a rim is raised vertically may be important because if the rim is not raised high enough, then a bug standing on the lip may not become separated enough from the access surface, thereby allowing the bug to maintain traction with the access surface. Likewise, if the lip is raised too high, small bugs, baby bugs or hatchlings may be unable to climb onto the rim. The height of outer rim 114, for example, may be the distance that outer rim 114 extends beyond the top of access surface 102, where access surface 102 may have a height 160. The height of outer rim 114 may be defined by the difference between the access slope height 160 and the height 128 of the device 100. In the example of FIG. 4, the outer rim height may be approximately 0.1 inches.

FIG. 4 may show additional details about the inner leg well 110. As can be seen in FIG. 1, inner leg well surface 112 may wrap around in a circular fashion to define the inner leg well 110. As can be seen in FIG. 4, inner leg well surface 112 (e.g., the parts of the of the inner leg well surface as it curves around) may be angled relative to central axis 124. As one example, FIG. 4 shows each part (each generally indicated by the number 112) of the inner leg well surface 112 angled such that each surface forms approximately a 15 degree angle (not shown) between the surface and the central axis 124. In this configuration, opposing parts of the inner leg well surface 112 may form an angle 150 between their curved surfaces, for example, an angle of about 30 degrees.

As can be seen in FIG. 4, inner leg well 110 may have a first diameter 152, and a second diameter 154. The first diameter 152 may be measured from the inner surface of the inner rim 116. The second diameter 154 may be measured from the outer surface of inner rim 116. The difference between the first diameter 152 and the second diameter 154 at any particular point of inner rim 116 (divided by 2) may define a horizontal thickness of inner rim 116. As one example, FIG. 4 shows a first diameter 152 of approximately 4.216 inches and a second diameter 154 of approximately 4.338 inches. In this example, the thickness of inner rim 116 may be approximately 0.061 inches.

As can be seen in FIG. 4, capture well 104 may have a first outer diameter 156 and a second outer diameter 158. The first outer diameter 156 may be measured from the inner surface of the outer rim 114. The second outer diameter 158 may be measured from the outer surface of outer rim 114. The difference between the first outer diameter 156 and the second outer diameter 158 at any particular point of outer rim 114 (divided by 2) may define a horizontal thickness of outer rim 114. As one example, FIG. 4 shows a first outer diameter 156 of approximately 5.294 inches and a second outer diameter 158 of approximately 5.428 inches. In this example, the thickness of outer rim 114 may be approximately 0.067 inches.

FIG. 4 may show additional details about the capture well 104, for example a horizontal width of the capture well 104. As one example, FIG. 4 shows that the inner width of capture well 104 may be defined by the first out diameter 156 and the second diameter 154. The difference between these two diameters (divided by 2) may define the width of the capture well. In the example of FIG. 4, the width may be approximately 0.478 inches.

FIG. 4 may show additional details about the raised rings, for example, the raised rings 136, 138, 140 as shown in FIG. 1. As can be seen in FIG. 1, a valley (e.g., valleys 137, 139, 141) may exist between each raised ring. FIG. 4 shows information about the diameter of each valley relative to central axis 124. As one example, FIG. 4 shows that valleys 137, 139, 141 have respective diameters of approximately 0.5 inches, 1 inch and 1.5 inches. Other embodiments may use various other ring and value placements, including various other valley diameter measurements.

FIG. 4 shows reference circles A, B and C. These reference circles indicate parts of the device illustration that may be blown up in the expanded views of FIGS. 5A, 5B, 6 and 7 respectively.

FIG. 5A shows an expanded view of reference circle/area A of FIG. 4. FIG. 5A may show more detailed information about access surface 102. The access surface 102 may be textured to create a surface that enables bed bugs to gain traction when walking on the access surface 102. That is, the surface may be, to some extent, rough and not smooth. The textured access surface 102 may be created in a number of ways during the device manufacturing process. For example, the texture may be created on the surface when the device is molded such that a textured surface of the mold imparts a similar textured surface onto the access surface of the device. In another example, initial texture or additional texture may be added after the molding process by sanding or scoring the access surface.

The amount of texture that is added to the access surface may be important because if the surface is too textured, the claws of bugs may become caught in the irregularities of the surface. Likewise, if the surface is not textured enough, the bugs may have a harder time gaining traction and, therefore, be less likely to climb the access surface 102. One purpose of the outer access surface may be to lure or lead a bed bug up onto the device, providing the bedbug with traction that the bedbug needs to walk up onto the device. The bedbug may walk up the outer access surface and proceed to the outer rim of the device.

FIG. 5A may show more detailed information about inner leg well 110. The inner leg well surface 112 and floor 111 (not shown in FIG. 5A) may have a texture similar to the outer access surface 102, for example, providing bed bugs with a readily climbable surface to permit escape from the leg of the piece of furniture (or other apparatus) that is placed in the inner well 110. Once bed bugs escape the inner leg well 110 and make their way onto the inner rim 116, they are much more prone to falling into the capture well 104. One purpose of the inner leg well may be to providing a bedbug with traction that the bedbug needs to walk onto the device, for example, form a leg of furniture. The bedbug may walk up the inner leg well surface and proceed to the inner rim of the device.

FIG. 5A may show more detailed information about capture well 104. Capture well 104 may be defined by at least one inner capture well wall 106, and at least one outer capture well wall 108 and a capture well floor 109. The number of capture well walls may depend on the shape of the footprint of the device as it sits on the floor. For example, the footprint of the device as it sits on the floor may be circular or oval and device 100 may have a single inner capture well wall 106 and a single outer capture well wall 108 (see FIG. 1). Although the following descriptions may refer to singular inner and/or outer capture well walls, it should be understood that a device may include more than one of each.

The capture well walls 106, 108 may be oriented vertically (or perpendicularly) in relation to a plane 122 parallel to the floor. In some embodiments, walls 106, 108 may be disposed substantially vertically (i.e. sloped a few degrees from vertical). In some embodiments, walls 106, 108 may be disposed at greater angles. As one example, FIG. 5A shows the inner capture well wall 106 and the outer capture well wall 108 each being oriented at approximately a 90 degree (e.g., between 85 and 95 degrees) angle (e.g., angle 164) in relation to a plane 122 parallel to the floor. A 90 degree angle (or a substantially 90 degree angle) may prevent bed bugs from being able to escape the capture well 104. A 90 degree angle may provide a benefit over various other pitfall traps which required the capture well walls to be covered in a powder to decrease traction. It should be noted that even though the capture well walls may be oriented at a 90 degree angle, multiple bug interception devices 100 may still be able to be stacked for storage, shipping, etc.

The capture well walls 106, 108 and floor 109 may be polished (i.e. have a low-friction surface) such that they are “slippery” to bed bugs and, thus, do not allow them to escape the well 104. In FIG. 5A, number 166 may generally indicate the areas of device 100 that may be polished. As can be seen, number 166 generally indicates well walls 106, 108, floor 109 and portions of outer rim 114 and inner rim 116. The polished surfaces may be created in a number of ways during the device manufacturing process. For example, the polished surface could be created when the device is molded such that a polished or smooth surface of the mold imparts a similar polished surface onto the surfaces of the device. In another example, initial polishing or additional polishing may be performed after the molding process by buffing for example.

FIG. 5A may show more detailed information about outer rim 114 and inner rim 116. The cross section of the outer and inner rims may vary in shape. For example, as shown in FIG. 5A, the outer surface of the outer rim 114 may extend vertically (e.g., perpendicular to plane 122) upward from the base 168 of the outer rim and then transition in a curved fashion (e.g., a rounded corner) into a top of the rim. Likewise, the top of the outer rim 114 may transition at the rim's inner portion in a curved fashion (e.g., a rounded corner) into the inner surface of the lip which falls off and then transitions into outer capture well surface 108. The cross sectional shape of the inner rim 116 may have a similar shape to that described for outer rim 114.

Each of the inner rim 114 and the outer rim 116 may have a top portion, i.e., the portion furthest away (perpendicularly) from the floor. In the embodiment shown in FIG. 5A, the tops of rims 114, 116 have a curved or domed shape. In other embodiments, the top of the rims may flatten off for a portion of the rim. FIG. 5B shows an example of an embodiment where the top of the outer rim 114 includes a flat portion 115. Inner rim 116 may include a similar flat portion. In these embodiments, the width 117 (e.g., horizontal length) of the flat portion(s) of the rim(s) may be an important feature of the bug interception device. The flat portion may determine whether a bug will walk along the rim, providing the bug the increased opportunity to accidentally slip and fall into the capture well. An overly narrow flat portion may cause a bug to avoid committing to walking up onto the top of the rim, and the bug may maintain its traction with the textured portion of the rim. An overly wide flat portion may provide a bug with too much room to safely walk around the rim without slipping and falling into the capture well. As one example, the flat portion of a rim may have a width 117 between (and including) ⅛ of an inch and ⅙ of an inch. As another example, the flat portion of a rim may have a width 117 of about 0.1 inches. Other widths may be used in various other embodiments.

Each of the outer rim 114 and the inner rim 116 may be texturized over a portion of its surface, for example, texturized with the same texture as that of the access surface 102. A texturized rim portion may allow a bug to crawl up the side of the rim onto the top of the rim. As shown in FIG. 5A, the outer surface of outer rim 114 and a portion of the outer rim 114 where it transitions into the top of the rim may be texturized Inner rim 116 may have a similar texturized portion. As explained herein, number 166 may generally indicate the areas that are polished. Number 166 of FIG. 5A may also indicate where the texturized areas start for each of the rims. As one example, the outer rim 114 may be texturized along its outer surface and along its outer rounded corner, up until an imaginary degree line (e.g., 75 degree the rim may be polished (e.g., like the capture well walls). Other degree lines may be used in various other embodiments, for example, degrees lines of approximately 75 degrees (e.g., between 70 and 80 degrees), or other degrees.

One purpose of the outer rim and inner rim each having a partially texturized and partially smooth surface may be to lure or lead a bed bug up onto the rim (e.g., from the outer access surface or the inner leg well), providing the bedbug with traction that the bedbug needs to walk up onto the rim. The bedbug may walk up the side of the rim and proceed to the top of the rim, near the texturized/polished degree line (e.g., 75 degree line). When the bedbug arrives at the degree line, the bedbug may be very close to a texturized/polished boundary, and at this point, it may be said that the bedbug is walking a tightrope of sorts. If the bedbug makes one misstep into the polished area of the rim, the bedbug may fall into the capture well. In this respect, the texturized/polished degree line offers a boundary that makes it likely that bedbugs will slip and fall into the capture well, for example, after they have been led up onto the rim.

As mentioned, each of outer rim 114 and inner rim 116 may be polished over a portion of their surfaces, for example, with the same polishing as the capture well walls. A rim with a polished portion may increase the chance that a bug will slip and fall while it walks along the rim. As shown in FIG. 5A, at outer rim 114 for example, the top of outer rim 114 and the portion of the rim where the rim transitions into the inner surface of the rim may be polished. More specifically, in one example, outer rim 114 may be polished along its top surface starting at an imaginary degree line (e.g., 75 degrees as shown in FIG. 5A), and continuing along the top surface, and into the inner rounded corner and inner surface of the rim. Other degree lines may be used in various other embodiments.

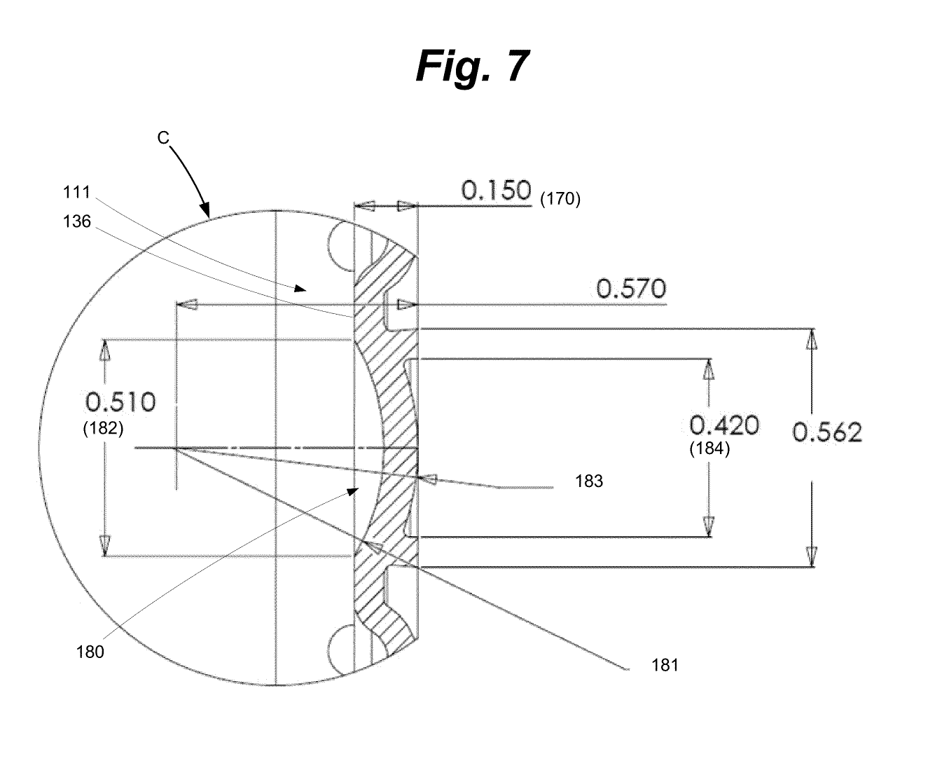

FIG. 6 shows an expanded view of reference circle/area B of FIG. 4. FIG. 6 may show more detailed information about a portion of inner leg well floor 111. As explained above, inner leg well floor 111 may include one or more raised rings and one or more valleys between raised rings. FIG. 6 shows a close-up of a raised ring 140 and a valley 141. As is shown by FIG. 6, the area of the inner leg well floor 111 where a raised ring (e.g., raised ring 140) transitions into a valley (e.g., valley 141) may include various surfaces, curves, bends, etc. For example, surfaces and/or bends 176, 178, 180, 182. FIG. 6 shows just one example of the contour (e.g., rate of bend, etc.) of these various surfaces and/or bends, for example, relative to a plane 125 parallel to central axis 124. In other embodiments, other contours may be used. As shown in FIG. 6, inner leg well floor 111 may have a thickness 170, which may include the overall thickness once various surfaces and bends of the raised rings and valleys have been accounted for.

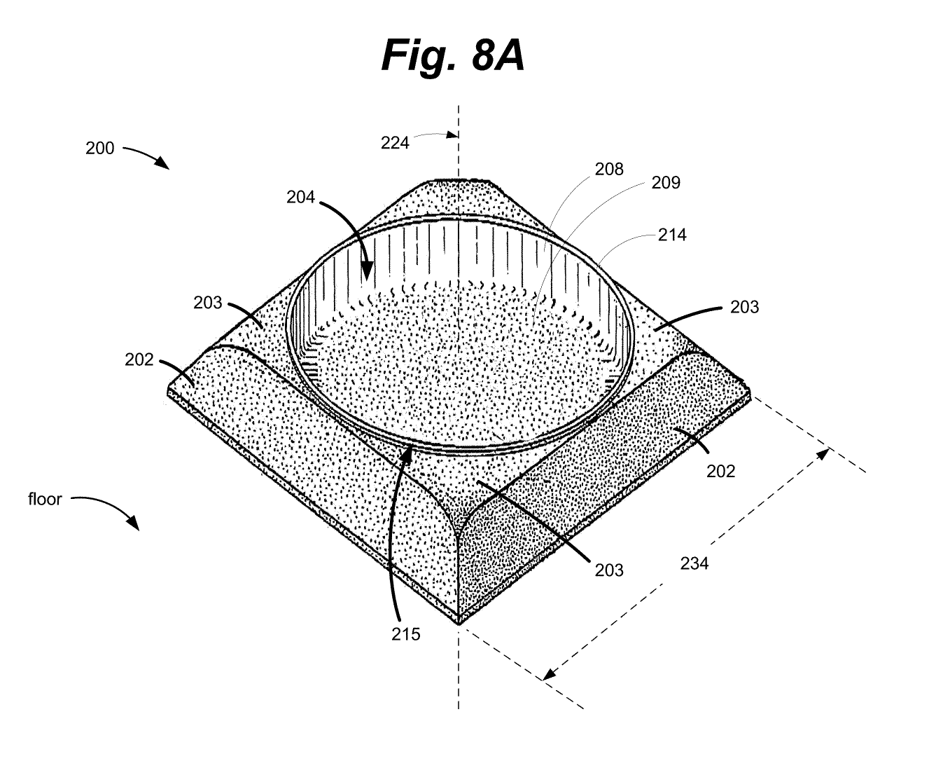

FIG. 7 shows an expanded view of reference circle/area C of FIG. 4. FIG. 7 may show more detailed information about a portion of inner leg well floor 111. As explained above, inner leg well floor 111 may include one or more raised rings and one or more valleys between raised rings. FIG. 7 shows a close-up of a raised ring 136 and a central valley 180. Raised ring 136 and a central valley 180 can also be seen in FIG. 1. Central valley 180 may have a top surface 181 and a bottom surface 183. Central valley 180 may have a top surface diameter 182 and a bottom surface diameter 184. In the example of FIG. 7, top surface diameter 182 may be about 0.51 inches and a bottom surface diameter 184 may be about 0.42 inches. FIG. 7 may show other measurements, angles and the like that may depict one example of how central valley 180 may be structured, curved and the like.

With regard to the descriptions provided in relation to FIGS. 1-7, it should be understood that the measurements, sizes, dimensions, angles and the like are provided as just one example of a bug interception device 100. Other embodiments may provide a bug interception device that is larger than the device 100 of FIG. 1. For example, a bug interception device could be larger or smaller (e.g., by a multiplication factor) than device 100. In these embodiments, all of the measurements as described with regard to FIGS. 1-7 may maintain their proportions with respect to each other. As another example, a bug interception device may be provided that includes different sizes and proportions of measurements, for example, where the measurements may all vary by up to 10 percent, 20 percent or more, and any percentage in between. In this respect, the present disclosure describes a bug interception device that has some or all of the general structural components described with regard to FIGS. 1-7; however, various embodiments may exclude one or more structural components and/or may vary the sizes and/or dimensions of components.

FIGS. 8A, 8B and 9 depict illustrations of an example bug interception device 200. The bug interception device of FIGS. 8 and 9 may be referred to as a pyramid device, for example, because the footprint of the device as it rests on the floor is shaped like a square and the sides of the device (e.g., the access surfaces) are sloped as they extend upwards. In various other embodiments, the footprint may be shaped like a triangle, or other geometric shape with a number of sides.

Referring to FIG. 8A, a bug interception device 200 is shown, where the bug interception device rests on a floor or other surface. FIG. 8B shows a more detailed view of bug interception device 200. In one or more embodiments of invention, the device 200 comprises three or more outer access surfaces 202, a capture well 204 and a lip or rim 214. Capture well 204 may be defined by a capture well wall or surface 208 and a capture well floor 209.

The number of outer access surfaces 202 may depend on the shape of the footprint of the device as it sits on the ground and the three dimensional shape of the device. For example, the footprint of the device as it sits on the ground may be square or some other polygon shape so that the device fits into the corner of a room. It may have four outer access surfaces 202 creating a three dimensional shape that resembles a four-sided pyramid as shown in FIG. 8A. Although the following descriptions may refer to a certain number of access surfaces, it should be understood that the device may include one or more.

In one or more embodiments of the present disclosure, the bug interception device 200 of FIGS. 8A, 8B and 9 may have many of the same angles and/or dimensions as described with regard to the device 100 of FIGS. 1-7. For example, in one specific embodiment, all of the features and angles (e.g., angles of the access slopes, capture well wall, etc.) are the same for the embodiments of FIGS. 8A, 8B and 9, except the features and/or angles necessary to implement the pyramid shape of the device 200.

For example, in some embodiments, the capture well wall 208 may be oriented at approximately a 90 degree (e.g., between 85 and 95 degrees) angle in relation to a plane parallel to the floor. As another example, each outer access surface 202 of device 200 may have a positive slope (e.g., 60 degrees) going from its bottom end to its top end, where the slope is in relation to the plane of the floor and the center axis 224 of the device. Additionally, the cross sectional length of the access surfaces 202 may be straight or curved. The outer access surfaces 202 may be textured similarly to the manner described above. The capture well 204 may be polished similarly to the manner described above.

In some embodiments, one or more dimensions of the bug interception device 200 may be different than dimensions described with regard to circular bug interception device 100. For example, the device 200 may have a base size that is smaller than the base of device 100. As one example, as shown in FIG. 8A, the device 200 may have a base width 234, for example, a base width of approximately 2.5 to 3 inches. It should be understood that in various other embodiments, the size, dimensions angles and the like of device 200 may change while still maintaining the general shape and features of device 200 as shown in FIG. 8A. For example, the device may be larger (e.g., a larger base width 234) or smaller or the device may be taller or shorter than depicted in FIG. 8A. As another example, capture well 204 may be smaller (in relation to the rest of the device 200) than is shown in FIG. 8A, which may result in differently sloped access surfaces 202 and/or may result in a taller device 200. These are just some examples, and other modifications will become apparent after referencing this disclosure.

Rim 214 may be similar to outer rim 114 described above. Rim 214 may be located near the meeting of the top of the access surfaces 202 and the top of the wall of the capture well 204, as shown in FIG. 8A. Many or all the details provided above with regard to outer rim 114 may apply to rim 214. For example, the cross sectional shape of rim 114 may be similar; rim 114 may be raised; rim 114 may include a flat portion like flat portion 115; and rim 114 may be partially texturized and partially polished as described above. For example, rim 114 may be polished along its top surface starting at an imaginary degree line (e.g., 75 degrees), and continuing inward along the top surface, and into the inner rounded corner and inner surface of the rim. Rim 114 may be texturized starting at the imaginary degree line and continuing outward along the top surface, and into the outer rounded corner and outer surface of the rim. Other degree lines may be used in various other embodiments.

Device 200 may include multiple top surface areas, for example, top surface areas 203. For example, top surface area 203 may be located near a top corner and/or edge formed by a meeting of two access surfaces (e.g., access surfaces 202). Top surface area 203 may have a triangular shape when viewed from a top down view. Top surface areas may merge into rim 214. In some embodiments, rim 214 may be raised up on a cylindrical wall 215. Wall 215 may have a textured outer surface similar to the texturized surfaces discussed above. FIG. 9 shows close up angled view of bug interception device 200. FIG. 9 shows a view of top surface area 203 and cylindrical wall 215 near outer rim 214.

The bug interception devices described herein (e.g., device 100 and device 200) may be formed from a variety of compositions or materials such as plastic. For example, plastic polycarbonate could be used because of its high strength properties, and its resistance to cracking. As another example, the device 100 may be formed of a polypropylene plastic and/or nylon. Old pitfall traps had problems with cracking under the weight of a bed leg, and thus using stronger materials such as polycarbonate to form the device may be preferred. However, other types of materials may be used such as recycled plastic, recycled polycarbonate, or other types of plastic.

One or more bug interception devices described herein (e.g., device 100) may be placed under a leg of furniture (or other apparatus) so that as crawling bed bugs either search for a host to feed on (and crawl toward a leg of furniture) or leave a host they have just fed on (and crawl down a leg of furniture), they will climb onto a portion of the bug interception device, climb onto a rim, and fall into the capture well. One or more bug interception devices described herein (e.g., device 200) may be placed in a corner of a room so that as crawling bed bugs crawl around a room (e.g., along the baseboard of a room), the bed bugs will crawl up one of the access surfaces, onto the rim, and fall into the capture well. One or more of the devices could also be placed at a random location in the middle of the floor of the infested structure (e.g., without being under a leg of furniture or in a corner of a room) to capture arthropods as they move about the floor.

1. A bug interception device for use with a leg of an apparatus comprising:
a circular shaped capture well having an inner capture well wall, an outer capture well wall and a capture well floor;
a circular shaped inner leg well for receiving a leg of the apparatus, said inner leg well having an inner leg well surface and an inner leg well floor, said inner leg well secured to said capture well and being located radially inwardly from said inner capture well wall;
an outer access surface disposed relative to said capture well and located radially outwardly from said outer capture well wall;
an inner rim located at the top of said inner capture well wall and the top of said inner leg well surface; and
an outer rim located at the top of said outer access surface and the top of said outer capture well wall, said outer rim having (1) a top surface of a curved configuration, (2) an outer surface merging with said outer access surface and (3) an inner surface merging with said outer capture well wall, and wherein said top surface has a first portion being texturized and a second portion being smooth.

2. The bug interception device of claim 1 wherein said outer surface of said outer rim is texturized, and wherein said inner surface of said outer rim is smooth, and wherein said top surface of said outer rim is texturized beginning from a line outwardly, and wherein said top surface of said outer rim is smooth beginning from said line inwardly, and wherein said line forms approximately a 75 degree angle in relation to a plane that runs perpendicular to a central axis, said central axis being perpendicular to said inner leg well floor.

3. The bug interception device of claim 1 wherein said inner rim has (1) a top surface of a curved configuration, and (2) an outer surface merging with said inner capture well wall and (3) an inner surface merging with said inner leg well surface, and wherein a first portion of said top surface of said inner rim is texturized a second portion of said top surface of said inner rim is smooth.

4. The bug interception device of claim 1 wherein said outer access surface is sloped at an angle relative to a central axis that runs perpendicular to said inner leg well floor, said angle being approximately 30 degrees.

5. The bug interception device of claim 1 wherein said inner capture well wall and said outer capture well wall are each oriented approximately 90 degrees in relation to a plane that runs parallel to said inner leg well floor.

6. The bug interception device of claim 1 wherein said outer access surface includes an outer textured surface, and wherein said inner leg well surface and said inner leg well floor each include an inner textured surface.

7. The bug interception device of claim 1 wherein said inner capture well wall, said outer capture well wall and said capture well floor each include a smooth surface.

8. A bug interception device comprising:
a capture well having an inner capture well wall, an outer capture well wall and a capture well floor;
an inner leg well, said inner leg well having an inner leg well surface and an inner leg well floor, said inner leg well secured to said capture well and being located radially inwardly from said inner capture well wall;
an outer access surface disposed relative to said capture well and located radially outwardly from said outer capture well wall;
an inner rim located at the top of said inner capture well wall and the top of said inner leg well surface; and
an outer rim located at the top of said outer access surface and the top of said outer capture well wall, said outer rim having a top surface of a curved configuration merging with said outer access surface and merging with said outer capture well wall, and wherein said top surface has a first portion being texturized and a second portion being smooth.

9. The bug interception device of claim 8 wherein said top surface of said outer rim is texturized beginning from a line outwardly, and wherein said top surface of said outer rim is smooth beginning from said line inwardly, and wherein said line forms approximately an obtuse angle in relation to a plane that runs perpendicular to a central axis, said central axis being perpendicular to said inner leg well floor.

10. The bug interception device of claim 1 wherein said inner rim has another top surface of a curved configuration, said another top surface having a first portion being texturized and a second portion being smooth.

11. A bug interception device for use with a leg of an apparatus, comprising:
a circular shaped capture well having an inner capture well wall, an outer capture well wall and a capture well floor;
a circular shaped inner leg well for receiving a leg of the apparatus, said inner leg well having an inner leg well surface and an inner leg well floor, said inner leg well secured to said capture well and being located radially inwardly from said inner capture well wall;
an outer access surface disposed relative to said capture well and located radially outwardly from said outer capture well wall, wherein said outer access surface is sloped at an angle relative to a central axis that runs perpendicular to said inner leg well floor, said angle being approximately 30 degrees;
an outer rim located at the top of said outer access surface and the top of said outer capture well wall; and
an inner rim located at the top of said inner capture well wall and the top of said inner leg well surface.

12. The bug interception device of claim 11 wherein said outer access surface includes an outer textured surface.

13. The bug interception device of claim 11 wherein said inner leg well surface and said inner leg well floor each include an inner textured surface.

14. The bug interception device of claim 11 wherein said inner capture well wall, said outer capture well wall and said capture well floor each include a smooth surface.

15. The bug interception device of claim 11 wherein said outer rim has (1) a top surface of a curved configuration, and (2) an outer surface merging with said outer access surface and (3) an inner surface merging with said outer capture well wall, and wherein a first portion of said top surface is texturized a second portion of said top surface is smooth.

16. The bug interception device of claim 15 wherein said outer surface of said outer rim is texturized, and wherein said inner surface of said outer rim is smooth, and wherein said top surface of said outer rim is texturized from a line outward, and wherein said top surface of said outer rim is smooth from said line inward, and wherein said line forms approximately a 75 degree angle in relation to a plane that runs perpendicular to a central axis, said central axis being perpendicular to said inner leg well floor.

17. The bug interception device of claim 11 wherein said inner capture well wall and said outer capture well wall are each oriented approximately 90 degrees in relation to a plane that runs parallel to said inner leg well floor.

18. A bug interception device comprising:
a circular shaped capture well having a capture well wall and a capture well floor;
three or more outer access surfaces disposed relative to said capture well and located radially outwardly from said capture well wall;
three or more corner edges, each corner edge being formed by the meeting of two outer access surfaces; and
a rim located at the top of said outer access surfaces and the top of said capture well wall, wherein said rim has (1) a top surface of a curved configuration, and (2) an outer surface merging with said outer access surfaces and (3) an inner surface merging with said capture well wall, and wherein a first portion of said top surface of said rim is texturized a second portion of said top surface of said rim is smooth.

19. The bug interception device of claim 18 further comprising three or more triangular shaped corner areas, each triangular shaped corner area being located near a corner edge and near said rim.

20. The bug interception device of claim 19 further comprising a cylindrical wall merging said triangular shaped corner areas to said rim.

21. The bug interception device of claim 20 wherein said triangular shaped corner areas and an outside surface of said cylindrical wall each include a textured surface.

22. The bug interception device of claim 18 wherein said outer access surfaces are each sloped at an angle relative to a central axis that runs perpendicular to said capture well floor, said angle being approximately 30 degrees.

23. The bug interception device of claim 18 wherein said capture well wall is oriented approximately 90 degrees in relation to a plane that runs parallel to said capture well floor.
